(19) United States
(12) Patent Application Publication
(10) Pub. No.: US 2006/0048202 A1
(43) Pub. Date: Mar. 2, 2006

(54) Method and apparatus for providing access to data at a consumer location

(76) Inventors: Raymond C. Bontempi, Jamison, PA (US); William J. Garrison, Warminster, PA (US); Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/024,108

(22) Filed: Dec. 28, 2004

Related U.S. Application Data
(60) Provisional application No. 60/605,958, filed on Aug. 31, 2004.

(51) Int. Cl. H04N 7/173

(52) U.S. Cl. 725/118; 725/126

(57) ABSTRACT

A method (500) for providing access to data at a consumer location (23). The consumer location (23) has a central consumer device (202) operable to access a data recording medium (402), a QAM interface (422) arranged for communication with a first remote consumer device (214), and a packet data interface (424) arranged for communication with a second remote consumer device (220). The method includes: arranging (502) for the central consumer device to receive the data from a broadband communication system; arranging (504) for storage of the received data on the data recording medium; arranging (506) for processing of a request in behalf of the first remote consumer device or the second remote consumer device, for access to the stored data; and arranging (508/510) for transmission of the stored data from the data recording medium to the requesting device via either the QAM interface or the packet data interface, as appropriate.

This application claims the benefit of provisional application No. 60/605,958, filed Aug. 31, 2004, the entire disclosure of which is incorporated by reference herein.

### BACKGROUND

Aspects of this invention relate generally to data distribution, and more particularly to a method and apparatuses for providing secure access to recorded data, such as audio/video content received from a broadband communication system, by multiple consumer appliances at a consumer location.

Program providers such as multiple system operators (“MSOs”) deliver data (pre-recorded or live electronic signals representing images and/or audio, software, or other data, in any format, and services including interactive television, Internet services, telephone services, video-on-demand services, and the like) from a variety of public and private sources to the homes of consumers via broadband communication systems such as cable networks.

MSOs may employ various types of data communication technologies to deliver data to consumers' homes over cable networks. Quadrature amplitude modulation (“QAM”) is the traditional interface for delivering data via a hybrid fiber-optic/coaxial cable (“HFC”) network. Packet data-based technologies delivered via cable modems and Fiber to the Home (FTTH) such as the Ethernet and Internet Protocol (“IP”), however, are increasingly being deployed by MSOs to deliver digital data to consumers.

A typical consumer is faced with many choices of wired and/or wireless home consumer appliances for receiving and rendering data, such as set-top boxes, IP audio devices, personal digital assistants, RF communication devices, cable modems, and the like, and generally also must decide what type of physical transmission media in which to invest—coaxial cable, Ethernet wiring, and/or wireless signal paths, for example.

Consumers are especially interested in acquiring consumer appliances that allow them to control the recording and home use of digital video and audio data, such as personal video recorders, digital versatile recorders, and audio/video hard disk devices, and consumer appliances having access to such internal or external hard drive-like storage devices.

Because MSOs are concerned with reducing the likelihood of illegal sharing of video and audio data (especially digital data), however, consumers are typically significantly restricted as to how and where they use recorded data, even within their own homes. Historically, recorded digital data has been encrypted in a manner that restricts its use to the consumer appliance that originally received and recorded the data, necessitating a consumer's use of multiple recording devices throughout the home. More recently, whole-home solutions have been proposed—in one example, two TiVO digital video recorders may share recorded content; in another example, a personal computer running Microsoft®'s Windows® XP Media Center Edition operating system may transmit stored audio/video programming to certain remote devices using packet data-based communication technologies.

Consumers having incompatible transmission media or consumer appliances, or consumer appliances that don't support packet data-based communication technologies (such as devices that receive QAM-modulated data over coaxial cables), however, are faced with the inconvenience and expense of replacing existing consumer appliances and/or adding additional transmission media throughout the home to take advantage of existing whole-home solutions.

There are, therefore, needs for methods and apparatuses that provide secure, ubiquitous access to recorded data by multiple home consumer appliances supporting different data communication technologies.

### SUMMARY

In accordance with an aspect of the present invention, a method provides access to data at a consumer location. The consumer location has a central consumer device operable to access a data recording medium, a quadrature amplitude modulation (“QAM”) interface arranged for communication with a first remote consumer device, and a packet data interface arranged for communication with a second remote consumer device. The method includes: arranging for the central consumer device to receive the data from a broadband communication system; arranging for storage of the received data on the data recording medium; arranging for processing of a request, in behalf of the first remote consumer device or the second remote consumer device, for access to the stored data; when the request for access to the stored data is in behalf of the first remote consumer device, arranging for transmission of the stored data from the data recording medium to the first remote consumer device via the QAM interface; and when the request for access to the stored data is in behalf of the second remote consumer device, arranging for transmission of the stored data from the data recording medium to the second remote consumer device via the packet data interface.

The broadband communication system may be a cable television system carrying data such as video programming to remote consumer devices such as set-top boxes over the same or different physical transmission media (for example, coaxial cable, fiber optic cable, twisted pair lines, wireless signals, power lines, and/or phone lines), the QAM interface may be a QAM modulator, the packet data interface may be an Internet Protocol (“IP”) adapter, such as a cable modem. The recorded data may be encrypted/decrypted using a key(s), and/or formatted according to the signal receiving capability(ies) of the remote consumer devices.

In accordance with another aspect of the present invention, a computer-readable medium is encoded with a computer program which, when loaded into a processor (such as a processor associated with the central consumer device), implements the foregoing method.

In accordance with a further aspect of the present invention, an apparatus (such as customer premises equipment) for providing access to data at a consumer location, includes: a quadrature amplitude modulation (“QAM”) interface responsive to a data recording medium; a packet data interface responsive to the data recording medium; a computer-readable storage medium; and a processor responsive to the computer-readable storage medium and to a computer program. When the computer program is loaded into the processor, it is operative to perform a method comprising: arranging for receipt of the data from a broadband communication system (such as a cable television system) arranging for storage of the received data on the (internal or external) data recording medium; arranging for processing of a request, in behalf of one of a first remote consumer device and a second remote consumer device, for access to the stored data; when the request for access to the stored data is in behalf of the first remote consumer device, arranging for transmission of the stored data from the data recording medium to the first remote consumer device via the QAM interface; and when the request for access to the stored data is in behalf of the second remote consumer device, arranging for transmission of the stored data from the data recording medium to the second remote consumer device via the packet data interface.

### BRIEF DESCRIPTION OF THE DRAWINGS

FIG. 1 is a block diagram of a typical broadband communication system operated by a multiple system operator.

FIG. 2 is a block diagram of a consumer location arranged to receive data from the headend of the broadband communication system shown in FIG. 1, in which various aspects of the present invention may be used.

FIG. 3 is a block diagram of a processing system, illustrating certain components accessible by, or included in, the devices at the consumer location shown in FIG. 2, in accordance with various aspects of the present invention.

FIG. 4 is a block diagram of the Media Hub shown in FIG. 2, in which various aspects of the present invention may be used.

FIG. 5 is a flowchart of a method for providing access to data at a consumer location, in accordance with various aspects of the present invention.

### DETAILED DESCRIPTION

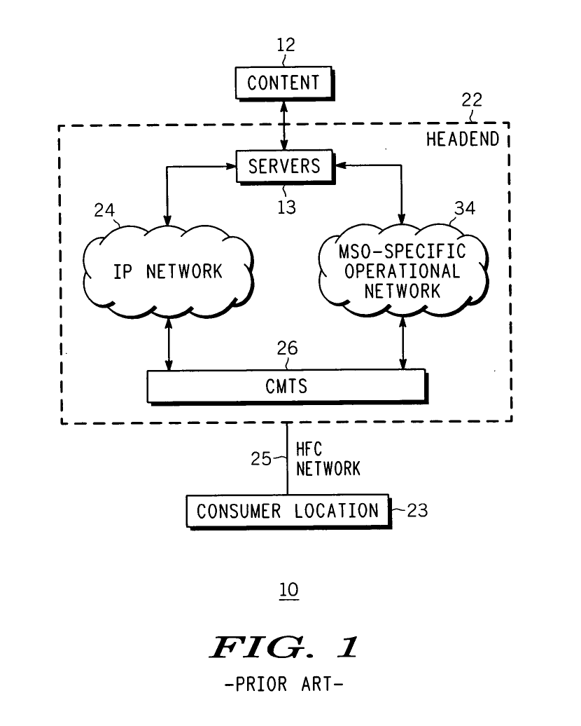

Turning now to the drawings, wherein like numerals designate like components, FIG. 1 is a block diagram of a typical broadband communication system 10, such as a cable network, operated by a multiple system operator (“MSO”). Using well-known components, methods and techniques, a headend 22 facilitates delivery of digital content 12 (which may be any pre-recorded or live electronic signals representing images and/or audio, software, or other data, in any format, and services including interactive television, Internet services, telephone services, video-on-demand services, and the like) over a hybrid fiber-optic/coaxial cable (“HFC”) network 25 to consumer appliances (not shown) at a consumer location 23, such as an area in or around a home, business, vehicle, or other local area. HFC network 25 may carry any type of upstream or downstream channels, including but not limited to out-of-band channels, broadcast channels, data carousel channels, or video-on-demand channels.

As shown in simplified form, headend 22 includes servers 13 and CMTSs 26, in communication via an IP network 24 and an MSO-specific operational network 34.

MSO-specific operational network 34 represents a collection of well-known reception and transmission components (not shown) such as servers/controllers, multiplexers, modulators, and network adapters and/or interfaces that operate in well-known manners to manage and control the processing of content 12 for delivery to consumer appliances operative to receive Quadrature Amplitude Modulation (“QAM”)-modulated downstream channels (not shown) (such consumer appliances are hereinafter referred to as “QAM Terminals”).

IP network 24 represents a collection of well-known packet data-based reception and transmission components (not shown) such as media gateways, signaling gateways, routers, switches, and firewalls, that operate in well-known manners to manage and control the processing of content 12 for delivery to consumer appliances operative to receive downstream channels (not shown) carrying packet data (such consumer appliances are hereinafter referred to as “IP Terminals”).

It will be understood, however, that system 10 and connections throughout may be any public or private, wired or wireless, content transmission infrastructure or technology for delivery of content 12, including but not limited to a fiber-optic network, a coaxial cable network, a satellite network, a cellular network, a wireless network, the Internet, a television network, a radio network, a copper wire network, or any other existing or future transmission infrastructure or technology, or any combination thereof, operated by any type of program provider, such as a television network or station, a studio, an Internet broadcaster or service provider, a cable operator, or a satellite operator.

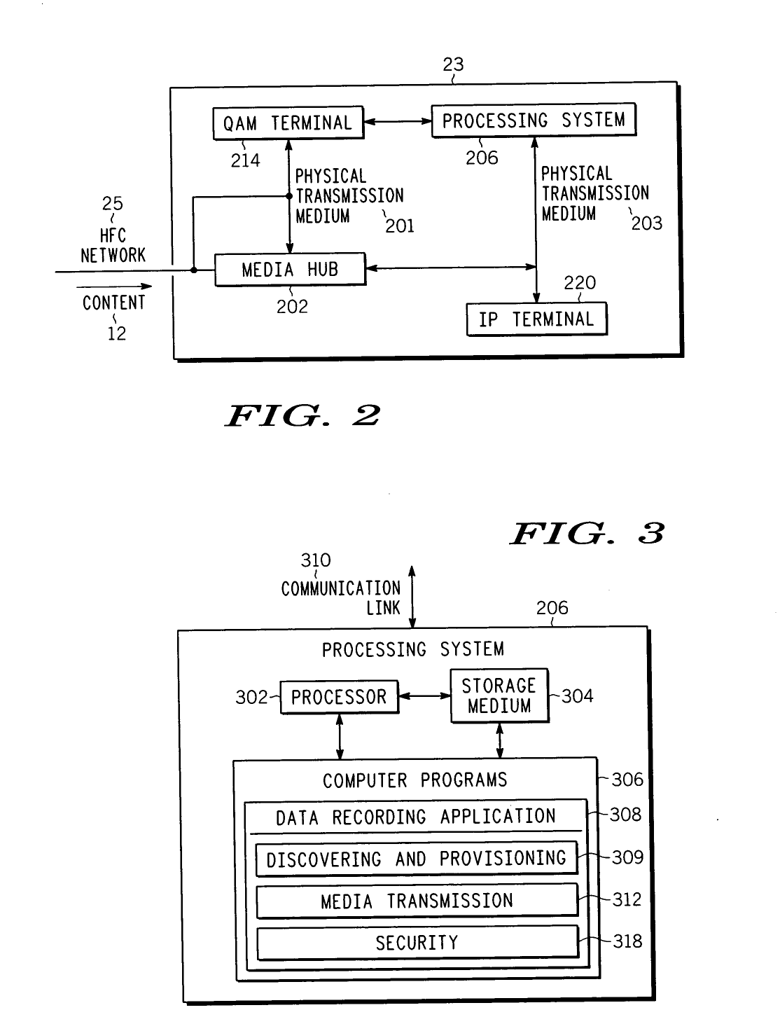

FIG. 2 is a block diagram of an arrangement of consumer location 23 (shown in FIG. 1) in accordance with various aspects of the present invention.

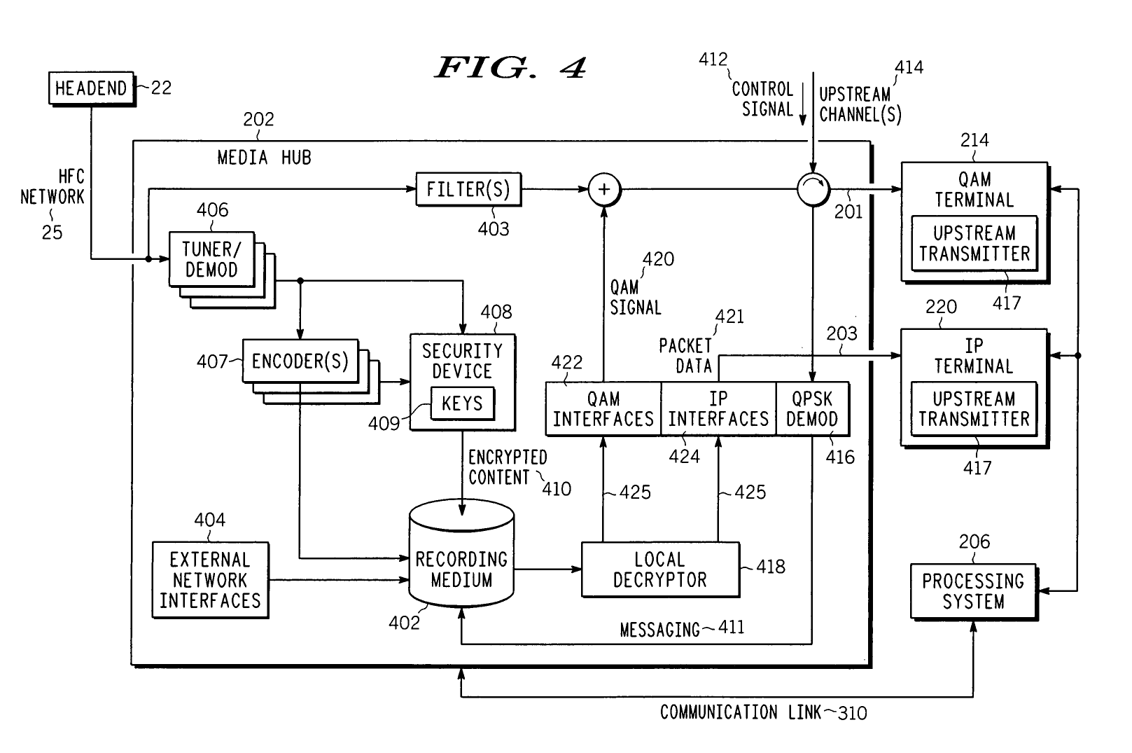

As shown, a media terminal 214, which is preferably a QAM Terminal (such as a set-top box—for example, a set-top box from Motorola's DCT series of cable receivers), and a media terminal 220, which is preferably an IP Terminal (such as a set-top box—for example, a QIP700 and/or Motorola's DCT2500 cable receiver) are arranged for communication with a Media Hub 202 (also discussed further below, in connection with FIG. 4) over physical transmission media 201 and 203, respectively. A processing system 206 (discussed further below, in connection with FIG. 3) is accessible by Media Hub 202, QAM Terminal 214 and IP Terminal 220.

Hereinafter, media terminal 214 will be referred to as “QAM Terminal 214,” and media terminal 220 will be referred to as “IP Terminal 220.” It will be appreciated that QAM Terminal 214 and IP Terminal 220 may be any device or combination of devices responsive to headend 22 capable of receiving and rendering content 12, including but not limited to home- or office-based personal computer systems, receiving, recording or playback devices (such as IP audio devices), stereo systems, personal computer/television devices, display devices, personal digital assistants, radiofrequency communication devices, voice-over-IP adapters, and other types of wired or wireless devices, either standing alone or included in other devices.

General internal arrangements, architectures and principles of operation of QAM Terminal 214 and IP Terminal 220 are well known to those skilled in the art. Aspects of the present invention described herein, however, may be implemented or executed by QAM Terminal 214 and IP Terminal 220 (for example, functionality associated with Data Recording Application 308 (shown in FIG. 3 and discussed further below)), and the operation/configurations of QAM Terminal 214 and IP Terminal 220 as adapted to implement or execute aspects of the present invention described herein are not deemed to be well-known.

Physical transmission medium 201 represents any medium over which QAM-modulated signals may be carried, such as an in-home coaxial cable network. Physical transmission medium 203 represents any medium over which packet data may be carried, such as twisted-pair copper wiring, optical fiber, or coaxial cable. It will be appreciated, however, that physical transmission media 201 and 203 may different media altogether, such as wireless signal paths or power line paths, operating to transmit signals in accordance with any applicable format or protocol. It will also be appreciated that additional consumer appliances and types thereof may be in physical communication with Media Hub 202 via transmission media 201 and 203.

FIG. 3 is a block diagram of processing system 206. The blocks depicted in processing system 206 are functions/components generally included in, or accessible by, QAM Terminal 214, IP Terminal 220, and Media Hub 202. As such, processing system 206 may be implemented centrally (by a personal computer, for example), or as separate systems/components located within, or accessible by, the consumer devices described herein, or any combination thereof.

A processor 302 is responsive to a computer-readable storage medium 304 and to computer programs 306. Computer-readable storage medium 304 may be any electrical, magnetic, optical, local or remote memory device or system, now known or later developed, capable of recording or storing data, and in particular may be, or may include, a read only memory (“ROM”), a flash memory, a random access memory (“RAM”), a hard disk drive, any type of compact disk or digital videodisk, and/or magnetic tape. It will be appreciated that the type of memory used may be dictated by the type data to be stored, and that computer-readable storage medium may include more than one type of memory.

Computer-readable storage medium 304 operates to store executable instructions, such as computer programs 306, which are loaded into a processor, such as processor 302, and executed.

Computer programs 306 are generally software components implemented according to well-known software engineering practices for component-based software development. Computer programs 306, however, may be any signal processing methods and/or stored instructions, in one or more parts, that electronically control or implement the functions discussed herein.

Data Recording Application block 308 represents aspects of the functional arrangement of various computer programs 306 accessible by Media Hub 202 (shown in FIG. 2), QAM Terminal 214 (shown in FIG. 2) and IP Terminal 220 (shown in FIG. 2) that pertain to the provisioning of certain recorded content 12 by Media Hub 202 to QAM Terminal 214 and IP Terminal 220, in accordance with aspects of the present invention. It will be understood that functions represented by block 308 that involve aspects of networking may operate at one or more of the seven vertical layers of the well known abstract model that defines internetworking (the “OSI Model”): layer 1, the Physical layer; layer 2, the Data Link Layer; layer 3, the Network Layer; layer 4, the Transport Layer; layer 5, the Session Layer; layer 6, the Presentation layer; and layer 7, the Application layer.

In general, Data Recoding Application block 308 includes the following functions: a Discovery and Provisioning function 309 that corresponds to a collection of activities relating to the set-up of media terminals in relation to Media Hub 202; a Media Transmission function 312 corresponding to to a collection of activities relating to the implementation of user interfaces, and the handling of user input therefrom, as those user interfaces relate to the provisioning (e.g., recording and playback) of recorded content by Media Hub 202 to QAM Terminal 214 and IP Terminal 220, as well as to the mechanics of communication between Media Hub 202 and QAM Terminal 214/IP Terminal 220; QAM Terminal 214/IP Terminal 220; and a Security function 318 that provides protection against unauthorized use and distribution of recorded content.

Computer-readable storage medium 304 also stores information usable by Data Recording Application 308 and functions thereof, for example: (1) configuration data associated with QAM Terminal 214 and IP Terminal 220 (user- and system-defined settings, communication settings, network settings, device receiving and/or display capabilities, device-specific conditions relating to access to certain data from Media Hub 202, device IP/media access control (“MAC”) addresses, and other unique device identifiers, such as serial or identification numbers, for example); (2) encryption keys 409 (shown and discussed in connection with FIG. 4); and (3) encoding algorithms/modules (not shown) usable by Encoder function 407 (shown and discussed in connection with FIG. 4).

Referring again to FIG. 2, Media Hub 202 functions to receive content 12 over HFC network 25, to accept requests from QAM Terminal 214 and IP Terminal 220 to record content and access selected content 12, and to transmit requested content 12 to QAM Terminal 214 and IP Terminal 220 in a secure manner, using communication technologies compatible with QAM Terminal 214 and IP Terminal 220. Media Hub 202 may act as a proxy for all content received over HFC network 25, or may only receive and process content requested to be recorded by QAM Terminal 214 or IP Terminal 220.

FIG. 4 is a block diagram of Media Hub 202. As shown, Media Hub 202 communicates with headend 22 over HFC network 25 on behalf of all consumer devices at consumer location 23—filters 403 (for example, notch filters or any other suitable filter) are operable to separate incoming data according to desired criteria such as frequency and destination device.

Media Hub 202 has access to processing system 206 (shown in detail in FIG. 3) or a like internal or external processing system, via communication link 310, such as a bus or serial link, which may be selected and implemented by one skilled in the art. It will be understood that certain functions of blocks/elements shown and discussed in connection with FIG. 4, which relate to aspects of the present invention, may be implemented by, in conjunction with, or in response to computer programs 306 (shown in FIG. 3), such as functional elements of Data Recording Application 308 (also shown in FIG. 3).

Media Hub 202 also has access to a recording medium 402, which may be any internal or external electrical, magnetic, optical, local or remote device or system, now known or later developed, capable of recording or storing data, including but not limited to a hard disk device, a personal video recorder, a digital versatile recorder, a VCR, a compact disk, a digital videodisk, a magnetic tape, or a PC/TV device. Recording medium 402 may be part of, or co-located with, storage medium 304 (shown in FIG. 3), for example. Recording medium 402 is used for recording selected content received by Media Hub 202, in response to requests from QAM Terminal 214 and IP Terminal 220. Recording medium 402 may also store such information as encoded bit rates, video resolution information, Digital Rights Management information, copy control indications, content titles, content information (for example, summary data on the content-actors, running time, ratings, and the like), recording time, access conditions, expiration information, access history, and other such information, created by any network device.

Media Hub includes one or more external network interfaces 404 for communication with other devices. External network interfaces 404 support, for example, devices such as modems (using various communication protocols and techniques, for example, SCTE55-1, SCTE 55-2, DOCSIS®, EuroDOCSIS®, DSL, or ISDN, among others), streaming media players and other network connection support devices and/or software that may be coupled through local or wide area networks (not shown) to program providers and providers of other content 12.

Tuner/demodulator block 406 receives downstream channel signals (not shown) from HFC network 25, and operates to demultiplex, demodulate, decompress (as applicable), and decode the signals. Internal arrangements and principles of operation of tuner/demodulator block 406 are well known. For example, one or more tuners within tuner/demodulator block 406 tunes to content selected by a consumer (not shown) via a user interface (not shown). The user interface may be associated with Media Hub 202, QAM Terminal 214, or IP Terminal 220, and may be any type of known or future device or technology (for example, a remote control, a mouse, a microphone, a keyboard, or a display) allowing the consumer to select content 12, such as channels, programming, services, or recorded data, that the consumer wishes to receive. One or more demodulators (for example, a digital demodulator device, such as a QAM demodulator, and a device, such as an NTSC demodulator, responsive to receive analog versions of a channel signal) are responsive to the tuner(s), and output demodulated data in analog or digital form. It will be appreciated that aspects of tuner/demodulator block 406 may be implemented by, or in conjunction with, elements of processing system 206, such as computer programs 306 (shown in FIG. 3).

An Encoder function 407 (for example, an MPEG encoder) is responsive to receive analog or digital video signals from tuner/demodulator block 406 that are not pre-encoded in formats receivable by QAM Terminal 214 and/or IP Terminal 220. Encoder function 407 is operative to perform predetermined coding techniques to: (1) arrange video information for transmission to QAM Terminal 214 and/or IP Terminal 220 (for example, arrange video into one or more formats receivable by QAM Terminal 214 and/or IP Terminal 220, and/or displayable by a display device (not shown), which may be in communication with Media Hub 202, QAM Terminal 214, and/or IP Terminal 220); and/or (2) arrange video information for storage in recording medium 402 (either directly or indirectly, via security device 408). Internal components of Encoder function 407, and operations thereof, are well known, and may include analog-to-digital converters, one or more storage media and/or buffers, and general or special-purpose processors or application-specific integrated circuits, arranged to produce multiple outputs in different formats. It will be appreciated that Encoder function 407 may be implemented by, or in conjunction with, elements of processing system 206, such as computer programs 306 (shown in FIG. 3).

A security device 408 is responsive to receive re-formatted digital video (i.e., information that was digitally encoded by Encoder function 407), and to receive pre-formatted digital video (i.e., digital video in formats receivable by QAM Reciever 14 and/or IP Terminal 220) from a digital demodulator device, such as a QAM demodulator, associated with tuner/demodulator block 406. Security device 408 functions to: (1) decrypt digital video information arriving from directly tuner/demodulator block 406 that was encrypted by headend 22, using well-known methods and techniques; and (2) protect against unauthorized use and distribution of content stored on recording medium 402, in accordance with aspects of the present invention.

Security device 408 provides protection against unauthorized use and distribution of content stored on recording medium 402 by locally encrypting (or re-encrypting, if the received information was previously encrypted by headend 22) content using predetermined encryption techniques and local encryption key(s) 409 (discussed further below) to form encrypted content 410. Encrypted content 410 is decryptable and usable only by those (such as QAM Terminal 214 and IP Terminal 220) having access—authorized by Media Hub 202—to certain local encryption key(s) 409. It will be appreciated that certain functional aspects of security device 408 may be implemented by, or in conjunction with, elements of processing system 206, such as computer programs 306 (shown in FIG. 3).

When Media Hub 202 is set-up for the first time, a locally generated key is created. Each media terminal in communication therewith has a unique X.509 certificate, which it sends to the Media Hub. The X.509 certificate is uniquely associated with an identifier of the media terminal (such as a MAC address, IP address, or a serial number) so that another device cannot masquerade as a valid media terminal. The X.509 certificate includes a public key associated with they media terminal. Media Hub 202 may store the public keys associated with the media terminals. The media terminals stores the keys and are able to decrypt encrypted content as it is transmitted (e.g., streamed). Media terminals may include the same tripleDES decryption engines and Media Hub 202. It will be appreciated that numerous variations are possible. For example, standard public key authentication methods may be used to establish a chain of authenticity back to the certification authority, as is commonly used in PKI systems. Challenge/response techniques may also be used between Media Hub 202 and media terminals to authenticate the media terminals—in this case, key exchange would likely use a public/private key-based sharing algorithm.

Recording medium 402 is responsive to messaging 411 (discussed further below), which includes instructions and information related to the recording and/or rendering of content 12 to/from recording medium 402 that is exchanged between QAM Terminal 214 and/or IP Terminal and Media Hub 202. Messaging 411 is the demodulated data received from quadrature phase shift key (“QPSK”) demodulator element 416, which operates in a well-known manner using well-known components (in coordination with elements of processing system 206, for example) to demodulate QPSK-modulated control signals 412 received over upstream channel(s) 414 by QPSK demodulator element 416. Control signals 412 are created by QAM Terminal 214 and IP Terminal 220 using upstream transmitters 417 (cable modems, for example) in well-known manners, and transmitted via upstream channel(s) 414 between QAM Terminal 214 and Media Hub 202 and between IP Terminal 220 and Media Hub over physical transmission medium 201 and physical transmission medium 203, respectively, using well-known techniques. Communication protocols utilized on upstream channel(s) 414 may be standard or proprietary protocols operating at various levels of the internetworking model.

Local Decryptor 418 receives encrypted content 410 from recording medium 402 for transmission as a digital transport stream 425 to QAM Interface 422 and/or IP Interface 424 in response to instructions and information received via messaging 411 and/or elements of processing system 206, such as computer programs 306 (shown in FIG. 3). More specifically, when Media Hub 202 authorizes transmission of recorded encrypted content from recording medium 402 to QAM Terminal 214 or IP Terminal 220, Local Decryptor 418 uses encryption key(s) 409 to manage the decryption of the selected recorded content by Media Hub 202 and/or QAM Terminal 214 or IP Terminal 220, and forwards digital transport stream 425 to QAM Interface 422 and/or IP Interface 424. The digital transport stream may also carry a set of authorization rights information (such as access conditions relating to the recorded content-right to copy and limits thereon, right to view and limits thereon, and the like—sent as messages or ancillary information bits) along with the selected recorded content itself. The authorization rights information may be accessible in the same manner (for example, using the same authorization code/key) as the recorded content. General internal arrangements, architectures and principles of operation of Local Decryptor 418 are well known to those skilled in the art.

QAM Interface 422 is arranged for receiving digital transport stream 425, and for configuring an output QAM signal 420 (i.e., a carrier onto which digital transport stream 425 is modulated) receivable by QAM Terminal 214 over physical transmission medium 201. Internal arrangements and principles of operation of QAM Interface 422 are well-known—QAM Interface 422 may include, for example, a QAM modulator (configured for 16-, 32-, 64-, 128-, or 256-QAM operation), an upconverter, a multiplexer, a transmitter, and other elements operating in well-known manners. It will be appreciated that certain functional aspects of QAM Interface 422 may be implemented by, or in conjunction with, elements of processing system 206, such as computer programs 306 (shown in FIG. 3).

IP Interface 424 is arranged for receiving digital transport stream 425, and for configuring an output packet data signal 421 receivable by IP Terminal 220 over physical transmission medium 203. Internal arrangements and principles of operation of IP Interface 424 are well-known—IP Interface 424 may include, for example, a protocol stack, such as a TCP/IP stack for encapsulating/framing digital transport stream 425 within data packets, software (such as computer programs 306) for processing the communication protocols that define communication between Media Hub 202 and IP Terminal 220, a virtual or hardware IP network adapter (for example, a cable modem), and an Ethernet port. IP Interface 424 can operate at any level of the OSI Model.

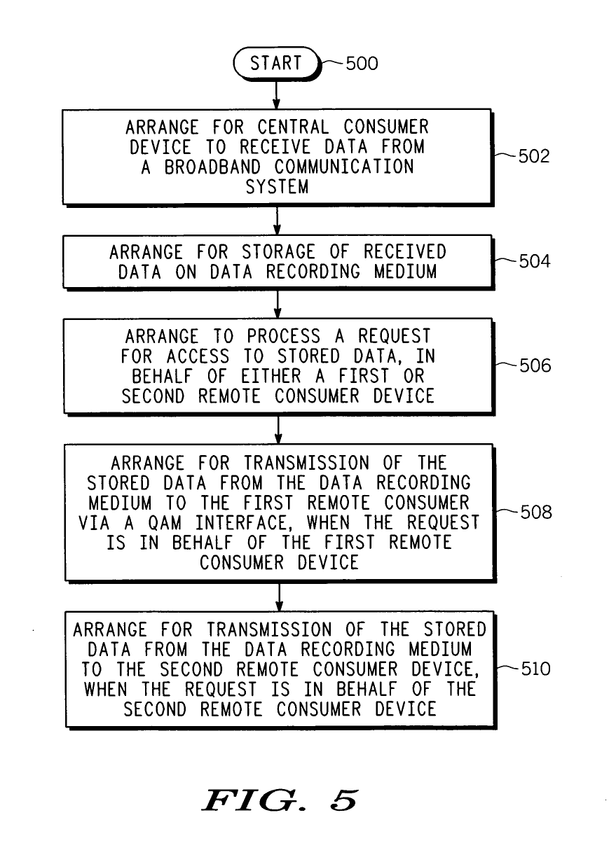

With continued reference to FIGS. 1-4, FIG. 5 is a flowchart of a method for providing access to data, such as content 12, at a consumer location, such as consumer location 23, in accordance with certain aspects of the present invention. The method may be implemented when one or more computer programs, such as computer programs 306 (for example, data recording application 308 and functions/modules thereof associated with Media Hub 202, QAM Terminal 214, and/or IP Terminal 220), are loaded into a processor, such as processor 302, and executed.

The consumer location has a central consumer device, such as Media Hub 202, which is operable to access a data recording medium, such as recording medium 402. The central consumer device has a QAM interface, such as QAM Interface 422, which is arranged for communication (via transmission medium 201, for example) with a first remote consumer device, such as QAM Terminal 214. The central consumer device also has an IP interface, such as IP Interface 424, which is arranged for communication (via transmission medium 203, for example) with a second remote consumer device, such as IP Terminal 220.

When a particular media terminal enters into a local network that includes Media Hub 202, the media terminal sends a discovery message to a well-known IP address and port on which the Media Hub is listening. Media Hub 202 responds, and provides the new media terminal with an IP address and provisioning information. Media Hub 202 may also initiate a key exchange process at this time—if Media Hub 202 is being established for the first time, a locally generated key may be created. Media terminals send their X.509 certificates, which contain the public keys associated with the media terminals, to the Media Hub. The public keys are used to encrypt the Media Hub's local key, and the encrypted public keys are sent to the media terminals.

The method begins at oval 500, and continues at block 502, where it is arranged for the central consumer device to receive the data from a broadband communication system, such as a cable television system.

In general, Media Hub 202 communicates with headend 22 over HFC network 25 on behalf of QAM Terminal 214 and IP Terminal 220 to receive content 12 from headend 22. More specifically, a consumer may select content for recording using a user interface associated with QAM Terminal, IP Terminal 220 or Media Hub 202. Once the consumer's selection has been communicated to Media Hub 202 (for example, via a recording request made by QAM Terminal 214 or IP Terminal 220 via upstream channel 414), Media Hub 202 may request and receive the selected content from headend 22.

At block 504, it is arranged for storage of the received data on the data recording medium.

Media Hub 202 may dynamically discover, or access previously stored, configuration data associated with the requesting consumer device and/or other devices within consumer location 23 that will have access to the stored content, to determine the format(s) in which to store the received content in recording medium 402. For example, device receiving and/or display capabilities/preferences, and device-specific conditions relating to access to certain received content (limitations on the type or amount of data that may be received, for example).

Based on the configuration data, Encoder function 407 may use predetermined encoding algorithms/modules to re-format (in one or more ways) the content received from headend 22 prior to storing the received content on recording medium 402.

Security device 408 may locally encrypt the received content using predetermined encryption techniques and local encryption key(s) 409 to form encrypted content 410, which is stored on recording medium 402.

Arrangements for processing a request for access to the stored data, in behalf of either the first remote consumer device or the second remote consumer device, are made at block 506.

A consumer may select recorded content for playback using a user interface such as a menu (the menu may include unique IDs associated with all recorded content) associated with QAM Terminal, IP Terminal 220 or Media Hub 202. Once the consumer's selection has been communicated to Media Hub 202 (for example, via a playback request made by QAM Terminal 214 or IP Terminal 220 via upstream channel 414 that includes the selected unique IDs), Media Hub 202 authorizes or denies the playback request based on security associations established by Security device 408 (for example, the requesting consumer device may have to demonstrate possession of a particular authorization code or key, such as the X.509 certificate and/or the Media Hub's local key, encrypted with the media terminal's public key).

When the request for access to the stored data is in behalf of the first remote consumer device, arrangements are made, at block 508, for transmission of the stored data from the data recording medium to the first remote consumer device via the QAM interface, and when the request for access to the stored data is in behalf of the second remote consumer device, arrangements are made, at block 510, for transmission of the stored data from the data recording medium to the second remote consumer device via the IP interface.

When playback requests are authorized, the appropriate stored content (for example, content having the appropriate format) is selected from recording medium 402 and passed to Local Decryptor 418. Encrypted content 410 may be decrypted by Local Decryptor (using encryption key(s) 409, for example) prior to transmission to the requesting consumer device, or it may be decrypted by the requesting consumer device upon arrival using the media terminal's public key

Local Decryptor 418 forwards digital transport stream 425 to QAM Interface 422 and/or IP Interface 424.

QAM Interface 422 configures QAM signal 420, receivable by QAM Terminal 214 over physical transmission medium 201. IP Interface 424 configures output packet data signal 421 receivable by IP Terminal 220 over physical transmission medium 203.

The receiving media terminal may control the flow of content into its own memory (for example, a buffer) by requesting the content in blocks. The media terminal may track the fullness of its buffer, and request more data to fill the buffer when it is running low, and stopping requests when the buffer fills up. Content may be pulled out of the buffer and displayed, as it is needed by the video decoding system.

Aspects of the present invention described herein address the need for methods and apparatuses for providing secure, ubiquitous access to recorded data by a number of consumer devices within the home, which may function on different transmission media/networks and/or support different data communication technologies. A centrally-accessible recording medium may be used to manage all recorded content for the home—allowing consumers more freedom to select content receiving devices/networks, and obviating the need multiple video recorders associated with receiving/display devices throughout the home, while maintaining the security of content transmitted over an MSO's broadband communication system.

It will be appreciated that aspects of the present invention are not limited to any specific embodiments of computer software or signal processing methods. For example, one or more processors and one or more computer programs packaged together or with other elements of Media Hub 202 or remote consumer devices 14 and 20 may implement functions described herein in a variety of ways. It will be understood, however, that the functions described herein are processes that convey or transform data in a predictable way, and may generally be implemented in hardware, software, firmware, or any combination thereof.

When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will furthermore be apparent that other and further forms of the invention, and embodiments other than the specific embodiments described above, may be devised without departing from the spirit and scope of the appended claims, and it is therefore intended that the scope of this invention will only be governed by the following claims.

1. A method for providing access to data at a consumer location, the consumer location having a central consumer device operable to access a data recording medium, the central consumer device having a quadrature amplitude modulation (“QAM”) interface arranged for communication with a first remote consumer device, and having a packet data interface arranged for communication with a second remote consumer device, the method comprising:
arranging for the central consumer device to receive the data from a broadband communication system;
arranging for storage of the received data on the data recording medium;
arranging for processing of a request, in behalf of one of the first remote consumer device and the second remote consumer device, for access to the stored data;
when the request for access to the stored data is in behalf of the first remote consumer device, arranging for transmission of the stored data from the data recording medium to the first remote consumer device via the QAM interface; and
when the request for access to the stored data is in behalf of the second remote consumer device, arranging for transmission of the stored data from the data recording medium to the second remote consumer device via the packet data interface.

2. The method according to claim 1, wherein the broadband communication system comprises a cable television system.

3. The method according to claim 1, wherein the QAM interface comprises a QAM modulator.

4. The method according to claim 3, wherein the packet data interface comprises an Internet Protocol (“IP”) adapter.

5. The method according to claim 4, wherein the IP adapter comprises a cable modem.

6. The method according to claim 2, wherein the data comprises video programming.

7. The method according to claim 6, wherein the first and second remote consumer devices comprise set-top boxes.

8. The method according to claim 1, wherein the first remote consumer device is arranged for communication with the central consumer device via a first physical transmission medium responsive to the QAM interface, and wherein the second remote consumer device is arranged for communication with the central consumer device via a second physical transmission medium responsive to the packet data interface.

9. The method according to claim 8, wherein the steps of arranging for transmission of the stored data from the data recording medium further comprise:
when the request for access to the stored data is in behalf of the first remote consumer device, arranging for placement of the stored data onto the first physical transmission medium using the QAM interface; and
when the request for access to the stored data is in behalf of the second remote consumer device, arranging for placement of the stored data onto the second physical transmission medium using the packet data interface.

10. The method according to claim 9, wherein the first and second transmission media comprise coaxial cable.

11. The method according to claim 9, wherein the first and second transmission media are selected from the group consisting of: coaxial cable, fiber optic cable, twisted pair lines, wireless, power lines, and phone lines.

12. The method according to claim 1, wherein the step of arranging for the central consumer device to receive the data from a broadband communication system further comprises:
receiving a record request from one of the first remote consumer device and the second remote consumer device to record the data;
based on the record request, acquiring the data from the broadband communication system.

13. The method according to claim 12, wherein the step of arranging for storage of the received data on the recording medium comprises:
encrypting the received data using an encryption key; and
storing the encrypted data on the data recording medium.

14. The method according to claim 13, wherein the step of arranging for processing of a request for access to the stored data comprises:
when the request for access to the stored data is in behalf of the first remote consumer device, determining a signal receiving capability of the first remote consumer device, and authorizing the first remote consumer device to receive the stored data; and
when the request for access to the stored data is in behalf of the second remote consumer device, determining a signal receiving capability of the second remote consumer device, and authorizing the second remote consumer device to receive the stored data.

15. A computer-readable medium encoded with a computer program which, when loaded into a processor, implements the method of claim 1.

16. The computer-readable medium according to claim 15, wherein the processor is associated with the central consumer device.

17. An apparatus for providing access to data at a consumer location, the apparatus comprising:
a quadrature amplitude modulation (“QAM”) interface responsive to a data recording medium;
a packet data interface responsive to the data recording medium;
a computer-readable storage medium; and
a processor responsive to the computer-readable storage medium and to a computer program, the computer program, when loaded into the processor, operative to perform a method comprising:
arranging for receipt of the data from a broadband communication system;
arranging for storage of the received data on the data recording medium;
arranging for processing of a request, in behalf of one of a first remote consumer device and a second remote consumer device, for access to the stored data;
when the request for access to the stored data is in behalf of the first remote consumer device, arranging for transmission of the stored data from the data recording medium to the first remote consumer device via the QAM interface; and
when the request for access to the stored data is in behalf of the second remote consumer device, arranging for transmission of the stored data from the data recording medium to the second remote consumer device via the packet data interface.

18. The apparatus according to claim 17, wherein the data recording medium is external to the apparatus.

19. The apparatus according to claim 17, wherein the apparatus comprises customer premises equipment, and the broadband communication system comprises a cable television system.
